(19) United States
(12) Patent Application Publication
(10) Pub. No.: US 2005/0182695 A1
(43) Pub. Date: Aug. 18, 2005

(54) Retail marketing method

(76) Inventors: Allen Lubow, Brooklyn, NY (US); Cary Bunin, Miami Beach, FL (US)

Correspondence Address: BROWN, RAYSMAN, MILLSTEIN, FELDER & STEINER LLP, 900 THIRD AVENUE, NEW YORK, NY, 10022, US

(21) Appl. No.: 11/008,786

(22) Filed: Dec. 8, 2004

Related U.S. Application Data
(63) Continuation-in-part of application No. 10/320,995, filed on Dec. 17, 2002.
(60) Provisional application No. 60/528,105, filed on Dec. 8, 2003.

(51) Int. Cl. G06F 17/60

(52) U.S. Cl. 705/28; 705/1

(57) ABSTRACT

A method is devised whereby a retailer may upgrade his operation by providing his suppliers (the vendors) with labeling standards including RFID and RSS bar code, guidelines for formatting and including in those labels additional supply chain logistical information, additional information including the item number, lot and expiration dates, the time and place of manufacture, descriptions in greater depth then was hitherto possible about the goods themselves, and a method of capturing that information and feeding it into the retailer's information management systems through customized forms and middleware. The retailer uses the services of an information management corporation that sets up this program with the retailer's suppliers, thereby eliminating the associated costs of augmenting his own systems. The retailer, vendors and customers profit by that additional information through various means of feedback, and extracting that information in useful ways that provide for greater inventory control, consumer safety, more efficient movement of merchandize, information about product content to the consumer, security, supply chain logistics, compliance with government regulations for the sale of retail goods, the bio-terrorism act as well as other government regulations and systems of pricing, rebates, coupons and returns by the customers.

### CROSS-REFERENCE TO RELATED APPLICATIONS

This application is a continuation-in-part of and claims the benefit under 35 U.S.C. § 120 from patent application Ser. No. 10/320,995, filed Dec. 17, 2002, the contents of which are incorporated by reference herein in its entirety. The present application also claims the benefit under 35 U.S.C. § 119(e) from provisional patent application No. 60/528,105, filed Dec. 8, 2003, the contents of which is incorporated by reference herein in its entirety.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

Information has become the keystone of any modern retailing concern. In order for the retailer to keep a competitive edge, expertise must be demonstrated in a number of areas such as supply chain logistics, inventory control, warehousing and tracking information management. In all other aspects of the retailing experience, as well, information management becomes key to enable the retailer to control the flow, storage, ordering, reordering, stocking, sale and delivery of goods and services along with compliance to government regulations for the marking and sale of retail goods. Without consideration for these other aspects of the retailing experiences, the competition edge is lost in today's marketplace.

Traditionally, the partnership established between the retailer and supplier sets standards for the communication of this information. In its simplest form, the retailer requires each supplier to label his goods and services with an item number. Those item numbers are printed on stock delivered to the retailer in machine-readable forms, e.g. UPC (A) bar code. This allowed the retailer to automate his systems of supply chain logistics, inventory, warehouse, retail sale and delivery.

As the systems dependent on that machine-readable data became more and more sophisticated, retailers recognize that more and better information provided in a timely manner would augment those supply chain logistics, inventory, sale and delivery systems. The landscape of retailing information systems is vast. On-Demand, FIFO, SAP, and so on earmark legacy systems retailers have implemented over the past twenty-five years. Any modern solution for retailers to upgrade their information management systems must include a method of adapting these legacy systems into the new information technology that is adopted.

Bar codes with greater information holding capacity, magnetic strips and RFID tags are used as methods for including that additional information.

It becomes clear that the retailer is a central figure in the augmentation of these retailing information systems since the retailer lies at the center of the universe of vendors who label their goods and services for that establishment. The retailer needs to be the standards setter for that additional information that the vendors print on their goods and services.

However, it also becomes clear that each new retailer initiative establishing standards for their vendors muddies the waters for all vendors. Which retailer's standard should be emulated? Does the five-hundred pound gorilla, the largest retailers, get to choose the standard(s)? Will those standards be acceptable for vendors of different sizes in different industries?

A method has been created which addresses all of these concerns in a way that can be marketed to retailers across a broad spectrum of industries. Moreover, that method becomes a win-win-win situation for the retailer, vendors and consumers alike. The retailer is given the means to implement such improvements in his systems without incurring great expense or startup costs. In fact, the method becomes a profit center in and of itself since the vendors would be asked to purchase the reporting, information gathering and labeling required to participate in the retailer system.

First, to accomplish this information systems upgrade, the retailer must study his existing information systems and decide what information is required to implement all of the programs between the various entities in the supply chain, retailing and consumer experiences that can enhance the ability of the retailer to sell goods and satisfy customers. Next, the retailer must create new information systems that can make use of additional information and create programs at all points in the retailing experience. Next, the vendors have to be given the requirements for the information they will need to supply along with their goods to the retailer. Next, the vendors have to be given the standards and guidelines for the labeling of their goods. Next, the retailer has to create a way to gather and receive the information required from the vendors. Next, the retailer has to create a way to take that information and incorporate it into the retailer's existing information database. These are huge, if not insurmountable, obstacles for any one retailer. One way to achieve these self-same goals is for a retailer to demand that it's largest vendors adopt and pay for new standards of information and communication. Vendors would likely exhibit enormous inertia towards going along with those demands when the retailer “twists arms” to get the job done without demonstrating how the supplier will profit by using these new standards.

### SUMMARY OF THE INVENTION

The system and method of the present invention relates to the management of information related to products and/or services (which may be referred to collectively as “goods”) sold by a retailer and supplied by vendor(s) to the retailer.

An embodiment of the invention provides a method for managing information related to goods sold by a retailer and supplied by a supply chain of at least one vendor. First, a developer creates a system for managing information related to the goods sold by the retailer and supplied by the supply chain. The information managed by the system is defined by the retailer. The system is designed so that the vendor(s) of the supply chain will provide the information defined by the retailer by associating the information with the goods prior to shipping the goods to the retailer. For example, the information may be encoded in a bar code label affixed to the goods or stored in the memory of an RFID tag affixed to the goods or some combination of the two. Next, the retailer administers the installation of the system across its supply chain by requiring each vendor of the chain to purchase the system from the developer and use the system as a condition to doing business with the retailer.

According to another embodiment of the invention, the retailer receives a fee for administering the installation of the system across the supply chain. For example, the fee may be paid to the retailer from the developer.

According to another embodiment of the invention, the fee received by the retailer may be based on the purchases made by the vendors of the chain. For example, the fee may be a portion of the purchase price of each system.

According to another embodiment of the invention, the retailer may receive goods from vendors of the supply chain that use the system, and then use the system to obtain the information associated with the received goods. Next, the retailer may provide at least some of the obtained information back to the at least one vendor of the supply chain that shipped the goods. The information sent back from the retailer to the vendor(s) of the chain may benefit those vendors by, for example, enabling the vendor(s) to determine the rate at which the goods supplied to the retailer are being sold and thereby adjust their rate of supply to the retailer accordingly.

Another embodiment of the invention provides a method for a developer to sell a system for managing information related to goods sold by a retailer and supplied by a supply chain of at least one vendor. First, the developer proposes to the retailer a program for installing the system across the retailer's supply chain in which each vendor of the chain is required to purchase the system developed by the developer and use the system as a condition for doing business with the retailer. If the retailer accepts the proposal, then the retailer institutes the program and notifies the vendor(s) of the chain of the requirement. The program may allow the vendor(s) to purchase the system from the developer through the retailer, with the retailer handling the processing of orders from the vendor(s) and arranging for delivery of the system from the developer to the vendor(s).

According to another embodiment, the retailer may receive a fee for administering the program. For example, the retailer may retain a portion of the purchase price of each system purchased.

According to another embodiment of the invention, the retailer may provide means through which consumer may be able to obtain additional information concerning goods. For example, a retailer may place kiosks in its stores that allow consumers to scan a bar code affixed to goods to thereby obtain additional information about that good that was provided by the vendor. For example, additional information for some goods, e.g., fruit, may include their country of origin so as to enable a consumer to select and purchase goods originating from certain locales. In another example, additional information that a consumer may obtain about a good may include detailed care instructions or possible allergic reactions, e.g., for food goods or medications. In addition, a retailer may provide such additional information to consumers in the form of real-time advertising. For example, where goods, e.g., food, from certain locales are highlighted positively or negatively in current news reports, the retailer may advertise goods to a consumer in a computer controlled, real-time display as being from or not being from a certain locale to match the news reports.

In an embodiment of the invention, a method is provided for managing information between businesses and vendors. First, a developer creates a system through which a business receives information associated with items provided to the business by a supply chain of at least one vendor. The system comprises a specification and one or more subsystems, wherein the specification is defined by at least the business and the specification defines the type of information to be received through the system, and wherein each of the one or more vendor subsystems enables an operator of the respective vendor subsystem to provide information conforming to the specification to the business by storing the conforming information in information storage devices and associating the information storage devices with items that are provided to the business. Next, the business facilitates installation of the system across the supply chain by requiring one or more of the at least one vendor to purchase one of the one or more vendor subsystems from the developer and operate the purchased vendor subsystem to provide information to the business as a condition to maintaining a business relationship with the business.

According to an embodiment of the invention, the information storage devices comprise bar codes.

According to a further embodiment, the information storage devices comprise RSS bar codes.

In another embodiment of the invention, the information storage devices comprise RFID tags.

In another embodiment of the invention, the developer pays a fee to the business for facilitating installation of the system across the supply chain.

According to a further embodiment, the fee is based on the purchases of the subsystems from the developer by the one or more of the at least one vendor.

According to another embodiment of the invention, the system comprises a business subsystem that enables the business to obtain information from the information storage devices associated with the items the business receives from each of the vendors operating a vendor subsystem, and that enables the business to send data to one or more of the vendors operating a vendor subsystem, wherein the data relates to the items previously received by the business from the one or more of the vendors operating a vendor subsystem.

In an embodiment of the invention, a method is provided for managing information associated with items between a business and one or more vendors. The method involves accessing, at the business, data from data storage devices associated with items received by the business from the one or more vendors, wherein the data stored in the data storage devices was selected by the one or more vendors based on requests issued by the business. The business then sends at least a portion of the accessed data to the one or more vendors. Finally, the one or more vendors determine sales related information associated with the items based on the sent portion of accessed data provided by the business to the one or more vendors.

According to an embodiment of the invention, accessing data associated with the items comprises reading a bar code label.

According to another embodiment of the invention, the bar code label comprises a Reduced Space Symbology (RSS) bar code.

In another embodiment of the invention, the bar code label comprises two-dimensional symbology.

In another embodiment of the invention, accessing data associated with the items comprises receiving the accessed data from a Radio Frequency Identifier (RFID) device.

According to another embodiment, data associated with the items comprises product information.

In another embodiment of the invention, the sales related information associated with the items comprises reordering requirement information.

According to a further embodiment of the invention, the reordering requirement information enable the one or more vendors to adjust production levels.

### BRIEF DISCRIPTION OF DRAWINGS

The invention is illustrated in the figures of the accompanying drawings, which are meant to be exemplary and not limiting, and in which like references are intended to refer to like or corresponding parts.

FIG. 1 illustrates a coupon processing system;

FIG. 2 illustrates a coupon processing method;

FIG. 3(a) illustrates a conventional UCC/EAN-128 coupon format;

FIG. 3(b) illustrates a first embodiment of a two-dimensional bar code combined with a UCC/EAN-128 bar code;

FIG. 3(c) illustrates a second embodiment of a two-dimensional bar code combined with a UCC/EAN-128 bar code;

FIG. 4(a) illustrates a two-dimensional bar code combined with a Code 128 bar code;

FIG. 4(b) illustrates a two-dimensional bar code combined with a UPC (A) bar code;

FIG. 4(c) illustrates a two-dimensional bar code combined with a stacked bar code;

FIGS. 5(a)-(g) illustrate examples of optimized coupon bar codes;

FIG. 6 illustrates a method for ensuring that coupons are redeemed only when the associated product has been purchased; and

FIG. 7 is a block diagram illustrating sample relationships between consumers, the retail store, the retail information systems and the retailer's suppliers.

### DETAILED DESCRIPTION

An outside information management company, e.g., an information systems developer, examines the retailer's operation to establish what information driven programs can be established that would augment the retailing experience for the consumer and increase profits for the retailer. It should be said that increased profits for both the retailer and vendor alike will be realized through good information management. Next, the necessary additional information that can facilitate those new programs must be established. Goods may currently be shipped to retailers carrying, e.g., in a bar code affixed to the good, only limited information such as price, date shipped, vendor identity, and retailer store number. However, the retailer would profit by knowing more information about the various SKU's such as color, size, gender, quantity, and so forth. That additional information may be determined for each SKU, and it might vary from one SKU to the next. Next, where the additional information is to be associated with goods supplied from the vendors to the retailer via RFID tags and/or barcodes, then the RFID tag formats with associated RSS barcode formats would be established. The necessary software and hardware to create and print those tags would have to be identified. Next, all of these new standards would be communicated to the vendors in the retailer's information program laid out to the vendors. At the same time, the retailer would have to establish middleware which would be designed to have forms that would accept vendor information coming from the vendor's existing database management systems and translate it into records that could be fed into the retailers information management systems.

To accomplish the retailer's program goals, the retailer may present each of its vendors with the following proposition: Using our new RFID/RSS bar coding standards we want you to label all of the goods sold and delivered to us as we describe. You will use the following software and hardware to label your goods. You will use the following forms and information management techniques to transmit the associated data. You will purchase that software and hardware through approved suppliers that we identify. In return, we will continue to do business with your company. We may also augment our relationship with you by giving you information which will make the sale of your products to us move profitable. Examples of how that additional information make the retailer/vendor relationships more profitable are: the retailer is better able to manage the reordering and increase the turns of inventory supplied by individual vendors, the vendors may use the information received back from the retailer to adjust their production levels, the retailer is better able to communicate to the customers what products are in stock, the retailer is better able to handle rebates, coupons and returns from the customers on behalf of the vendors, the retailer is better able to facilitate the reordering of stock to its distribution channels through greater logistical efficiencies in more timely ways, and so on.

Advantages for the retailer for using an outside enterprise to set up this information system are many. First, the retailer does not have to reinvent its own information system from scratch. An existing system can be augmented with middleware which can be tailored to receive and integrate the new data into an existing system. Second, the retailer does not have to pay for the improvements to his system. Those costs are shared by his suppliers, the vendors. Third, the vendors do not have to invent ways of fulfilling the retailer's new system requirements. Software and hardware is identified that the vendors can purchase, off-the-shelf, that would fulfill the retailer requirements. This makes adoption of the retailer programs that much more palatable for the vendors. In addition, purchasing a system already developed by the outside enterprise for a reasonable price may spread the cost of the development of the system more efficiently over a plurality of vendors as compared to the case where a retailer may ask vendors to create their own information systems to operate according to guidelines specified by the retailer. Fourth, where RFID/RSS barcode tags are used as labels, then the conversion from the existing systems of item identification to the new standards may be made to appear transparent since such new labels may be readable by existing systems. As the new readers and scanners are put in place, the additional information is readable by the vendors and transmittable to the retailers.

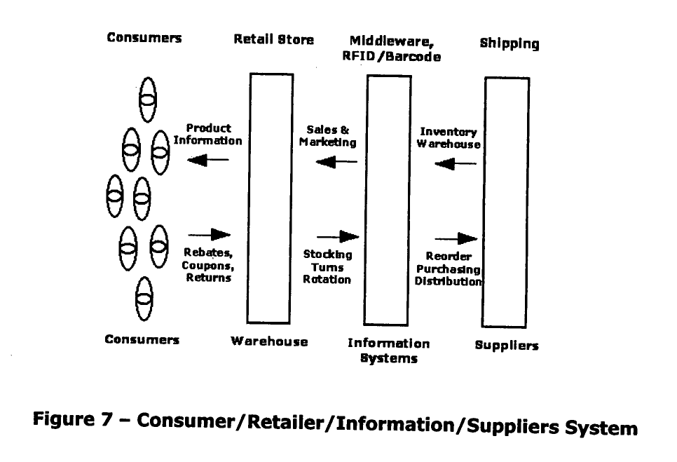

FIG. 7 illustrates sample relationships between consumers, the retail store, the retail information systems and the retailer's suppliers (the vendors). The information used to communicate between the different entities all begins with the vendors. That information, in the form of product information (e.g., item number (UPC), expiration date, lot numbers, serial number, in depth product descriptions, manufacturing place and time, and so forth), may be attached to the goods themselves, for example, in the form of RFID tags with corresponding RSS bar code. When the goods arrive at the retailer warehouse or distribution center, the associated information is scanned into the retailer's information systems through the use of forms and middleware. That information is used to create the various sales and marketing propositions used in the retail stores. For example, where goods, e.g., food, from certain locales are highlighted positively or negatively in current news reports, the retailer may advertise goods to a consumer in a computer controlled, real-time display as being from or not being from a certain locale to match the news reports. Furthermore, the associated information is used to provide product information to the consumers. That information may also be used to help consumers with rebates, coupons, and returns. The retailer augments his system with information about the goods as they pass from retailer to consumer in the stores. Information about stocking and purchasing habits is relayed to suppliers in the form of reordering and distribution requirements to the vendors. By augmenting the flow and quality of information throughout the retailing experience, the retailer is able to profit by leveraging those advantages.

By way of example, the additional information gathered and transmitted to the consumer and back to the vendor could be used to facilitate the organization of a more effective rebate and coupon program offered by the vendors through the stores. Current systems lack the ability of the store to offer the consumers accurate information about coupon and rebate offers. Current systems lack the ability of the store to communicate the consumer's information back to the vendors. Therefore, the consumer is left to speak directly with the vendor either with mail or via the Internet. This precludes the retailer from participating in the coupon process to a large extent. The consumer is also faced with the task of demonstrating to the vendor that, in fact, the vendor's products were purchased from that retailer in a timely way. The vendor treats the consumer more like a thief then a customer. The benefits of coupon distribution are minimized and whatever benefits the retailer could have realized through the coupon program is lost. By having the coupon information flow through the retailer's own information systems, the consumer, retailer and vendor may all benefit. Rebates can be given more freely with more trustworthy information about the consumer, the products purchased and the retail locations.

Utilizing the invention described above, there are several techniques through which the additional information gathered and transmitted to the consumer and back to the vendor could be used to facilitate the organization of a more effective rebate and coupon program offered by the vendors through the retailer. Examples of such techniques are described in further detail below.

By changing the symbology used on coupons from the UCC/EAN-128 code to Reduced Space Symbology (RSS) or other compact and/or two-dimensional symbology, coupons with greatly enhanced functionality can be made due to the enormous additional information that can be contained in the bar code symbols. Further, by emulating the format of a credit card transaction, coupons employing bar codes, magnetic stripes and smart cards can be processed as credit card transactions using the existing or legacy credit card processing infrastructure. This affords the benefits of speedy processing of the monies involved as well as conveying additional data associated with the coupons, thereby opening up tremendous new marketing opportunities. The tedium of collecting coupons for redemption by a redemption center is also avoided. Moreover, the invention can be phased in conveniently by providing bar-coded coupons with both one-dimensional and two-dimensional symbols.

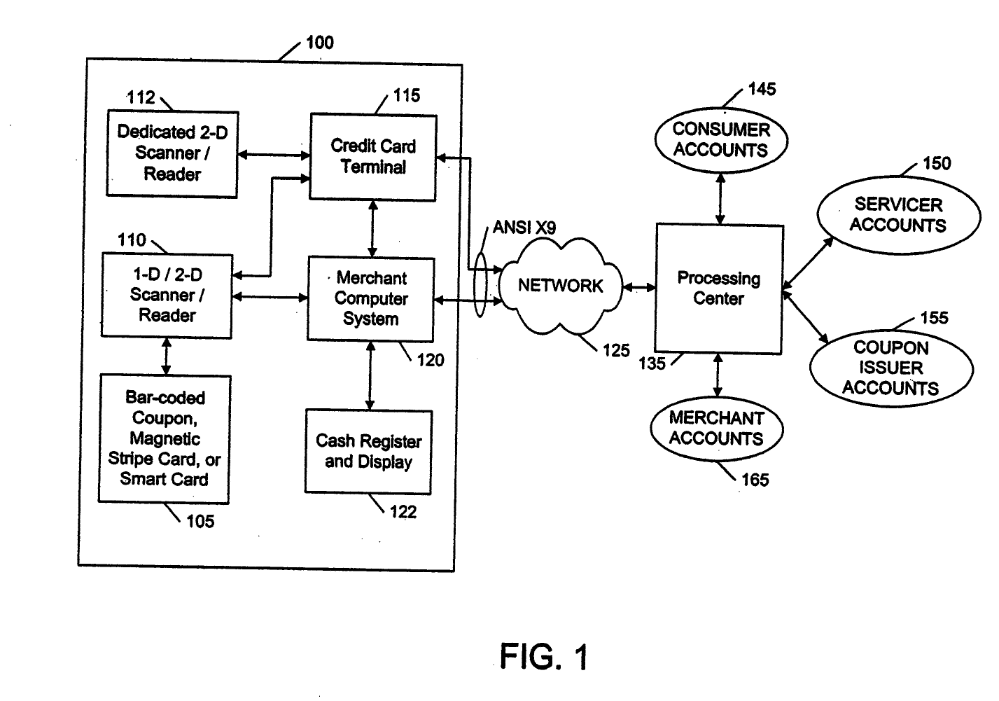

FIG. 1 illustrates a coupon processing system. A point of sale (POS) location 100 may be a retail store, self-serve kiosk, virtual location, a consumer's home, or other business location where a merchant sells products or services. The term “merchant” is meant to encompass essentially any business that provides a product or service, including businesses serving the public, the government, business-to-business, and so forth. The terms “sell”, “purchase” and the like are meant to encompass sales in the conventional sense as well as rental of products and other arrangements. A scanner/reader 110 scans a bar-coded coupon 105, or reads a magnetic stripe card or smart card, e.g., a coupon card, any of which is encoded with data according to the invention. The scanner/reader 110 is provided with software for reading the information and communicating it to a merchant computer system 120 or a credit card terminal 115. A magnetic strip card may be read using a known swipe reader while a smart card may be read using a known smart card reader. Thus, in addition to bar-coded coupons comprising a bar code symbol printed on a substrate such as paper, the invention may be used with other data storage media such as magnetic stripe cards and smart cards that store the equivalent data. Many modern POS locations already have scanners that can read both one-dimensional and two-dimensional bar codes. An example of an RSS-enabled scanner is the Cyclone made by Symbol Technologies, Inc. If the scanner 110 can only read 1-D bar codes but not 2-D bar codes, e.g., the scanner 110 is not RSS-compatible, the conventional bar code portion of the coupon can be read. Or, a separate, dedicated 2-D scanner 112 that is RSS-compatible may be provided. The scanner/reader 112 may be a standalone RSS coupon terminal that works in conjunction with the credit card terminal 115. It requires power and a telephone line, which may be shared with other terminals/scanners. The scanner/reader 112 may use a second handheld scanner that is placed at the checkout counter for scanning RSS coupons only. Thus, when the scanner/reader 110 is not RSS compatible, the separate dedicated scanner/reader 112 may be used to scan or read the coupon. If the scanner/reader 110 is RSS compatible, the separate dedicated scanner/reader 112 is not needed. Moreover, the coupons may have graphics and supporting text that inform the cashier and consumer that they require processing by a 2-D scanner.

Scanning equipment for 2-D bar codes is becoming affordable enough for even small businesses. In fact, the benefits derived from the invention will encourage businesses that previously did not have a need for scanners to obtain one. This includes service industry businesses, e.g., hair salons, travel agencies, entertainment facilities, and the like, that mainly provide services to consumers rather than products. The cashier and consumer need no special training since the coupons provided according to the invention are handled and scanned in the same way as convention coupons. Moreover, since all processing occurs electronically, the coupons can be discarded after they are scanned. Discarded coupons are destroyed, e.g., by shredding, to prevent misuse. A shredder may be built into the scanner/reader 110 or 112 for this purpose.

The scanners/readers 110 or 112 communicate with a credit card terminal 115, which may have a swipe reader and a keypad. An RS232 port on the credit card terminal 115 may be used to receive data from the scanners/readers 110 or 112. Such ports are made available for interfacing with peripheral devices such as keyboards. The credit card terminal 115 may be of the type that is ubiquitous in businesses that accept credit cards and debit cards as payment for their products or services. VeriFone, Inc. is one major supplier. Generally, the coupon information can be conveyed to the credit card terminal 115 via a variety of means, such as manually typing in the information, reading the bar code and transmitting the data to the unit as ASCII text, or magnetic stripe or smart card reading if the coupon offer was so designed. The scanner 110 may communicate with a merchant computer system 120, if available, e.g., via an RS232 link. The merchant computer system 120 may store information regarding products purchased, sales figures and the like, for inventory control and other purposes. The merchant computer system 120 may also store coupon information from the scanner 110. A cash register and display 122 may communicate with the merchant computer system 120 as known in the art to inform the consumer of the price of each purchased item.

According to the invention, the information that is obtained by the scanner/reader 110 or 112 may include an account identifier, such as a credit card or debit card number, of the coupon issuer, which is the entity that is applying for the discount provided by the coupon. As explained further below, the use of such an account identifier allows a coupon to be electronically processed using the existing credit and debit card processing infrastructure, including the existing scanner/reader 110, credit card terminal 115 and the upstream processing facilities and protocols already in place. Other coupon transaction information, such as the product and discount, are piggybacked onto the account identifier and likewise communicated from the credit card terminal to the upstream facilities. The coupon discount may be provided as a fixed amount or as a percentage of the regular price of an item. In one approach, the credit card terminal 115 processes the coupon information from the scanner/readers 110 or 112. In another approach, the coupon information is processed by the merchant computer system 120, which has an analogous functionality as the credit card terminal 115. In either case, the coupon transaction information for different transactions may be stored in the credit card terminal 115 or merchant computer system 120. Periodically, such as daily, the coupon transaction information is uploaded to a processing center 135 as a batch job via a communication network 125 such as a telephone network. Importantly, the coupon transaction information is communicated using the existing protocols for credit and debit card purchases. There are several related standards or protocols that describe a credit or debit card transaction. The basic standard is ANSI X9.1-1991, entitled Bank Cards Magnetic Strip Data Content for Track 3, incorporated herein by reference. In accordance with the invention, the data read in from the coupon bar code may emulate the track 3 data. However, many variations are possible, and the invention can be used with any credit or debit card processing scheme. The batching and processing of coupon data may be performed according to a schedule of services provided by the processing center 135.

The ANSI X9 standard provides for the communication of transaction information such as credit or debit card number, card/payment type, expiration date, whether card and consumer are present, transaction amount, merchant identifier, security/authorization code that is manually entered by the cashier, such as a customer zip code, transaction date and time, and other information. As used with the present invention, this information may be referred to as “coupon transaction information.” In conventional transactions where a consumer pays for an item using a credit card, up to 105 characters of ANSI information appear on the consumer's credit card statements for a transaction to provide the consumer with a record of the transaction. However, with the present invention, the account identifier is associated with the coupon issuer, and the coupon information, including the discount amount, product identifier, consumer data and other information, may be carried in the 105 characters.

In particular, a subset of ANSI X9 is the ANSI X9.59 Payment Card Process, which may include the following data element. This may be typical of what is expected in a credit card transaction. This standard is applicable as well to debit cards. A payment card refers to a credit card or debit card.

X9.59 signed payment elements:

| | |
|---|---|
| StandardVersion | X9.59 protocol version |
| Paycode | payment instructions to merchant |
| PrcC | customer account number (becomes the coupon issuer |
| | account number) |
| LUID | (customer) locally unique identifier |
| PrcM | merchant account number/id |
| PaydataC | currency type and transaction amount |
| DateS | transaction date/time |
| DateE | account expiration |
| SHS {OD} | hash of order detail |
| DSS {VD} | digital signature of X9.59 signed elements |

The X9.59 addenda field:

| | |
|---|---|
| StandardVersion | X9.59 protocol version |
| Paycode | payment instructions to merchant |
| LUID | (customer) locally unique identifier |
| DateS | transaction date/time |
| SHS {OD} | hash of order detail |
| DSS {VD} | digital signature of X9.59 signed elements |

However, many variations are possible, and the invention is meant to encompass any credit card processing scheme.

The invention is meant to be suitable for use with any type of account identifier that can be processed to obtain a payment from a coupon issuer. This includes account numbers of credit cards, including universal credit cards, affinity cards, bank cards issued by banks, such as Visa, MasterCard and Discover Card, travel and entertainment cards, such as American Express, Diners Club and Carte Blanche, house cards that are good only in a particular business or chain of businesses, such as a department store or gas station chain, or phone companies, as well as debit cards, which can be processed the same as credit cards using the ANSI X9 standard. Most national credit cards and debit cards have a numbering system that follows the ANSI Standard X4.13-1983 standard, while house cards, gas cards, and phone cards often follow their own system. The phrases “credit card number” and “debit card number” and the like are meant to encompass any credit card or debit card identifier, respectively, whether it includes a string of numerals, letters, other symbols, or any combination thereof.

Under, ANSI Standard X4.13, the credit or debit card has a 15-digit account number and one check digit. The first digit in the credit-card number signifies the system, e.g., 3 for travel/entertainment cards, 4 for Visa, 5 for MasterCard, and 6 for Discover Card. The structure of the card number varies by system. For example, American Express card numbers start with 37; Carte Blanche and Diners Club with 38. For American Express—Digits three and four are type and currency, digits five through 11 are the account number, digits 12 through 14 are the card number within the account and digit 15 is a check digit. for Visa—Digits two through six are the bank number, digits seven through 12 or seven through 15 are the account number and digit 13 or 16 is a check digit. For MasterCard—Digits two and three, two through four, two through five or two through six are the bank number (depending on whether digit two is a 1, 2, 3 or other). The digits after the bank number up through digit 15 are the account number, and digit 16 is a check digit.

Optionally, the coupon transaction information may be processed immediately after each transaction. A further option is for the credit card terminal 115 to obtain an authorization code for each transaction from the processing center 135. The authorization code assures that the credit account is in good standing and that there is a sufficient balance available. It is the same authorization code that is received for conventional credit card purchases, and may be obtained in specified situations. For example, an authorization code may be obtained when the coupon discount exceeds a certain dollar amount. This can be achieved, e.g., using software that checks the discount amount to see if it exceeds a given amount. The code is stored by the credit card terminal 115 and periodically uploaded to the processing center 135 as discussed above. The merchant may wish to obtain authorization codes depending on its agreement with the provider of the credit card terminal 115. For example, the merchant may be charged a lower monthly fee for using the terminal if it agrees to obtain authorization codes for transactions since fewer unauthorized or fraudulent transactions will occur. On the other hand, a delay may be incurred during the checkout process while waiting for the code.

The processing center 135, which may be associated with a bank, for instance, processes the coupon transaction information received from the POS 100 as if it was a conventional consumer credit or debit card purchase. However, in accordance with the invention, since the account identifier in the coupon transaction information is associated with the coupon issuer, and not the consumer, the coupon issuer's account 155 is charged for the discount amount of the coupon. A service charge may also be assessed by the processing center 135 or other involved entities and maintained at servicer accounts 150. This fee may be analogous to the processing fee assessed in conventional credit or debit card transactions, e.g., a fixed fee or percentage. The discount amount that is included in the coupon transaction information is then credited to the account 165 of the merchant who accepted the coupon. The merchant may be identified by the merchant identifier that is communicated to the processing center 135 with the coupon transaction information using the existing protocols. A database at the processing center 135 may associate the merchant identifier with a merchant account number for an electronic funds transfer (EFT). Or, the merchant account number itself may be carried in the coupon transaction information in which case no database lookup is required to route the reimbursement. It is also possible for a credit to be given to the consumer's account, as discussed further below. Advantageously, the merchant can be reimbursed very quickly, e.g., in matter of one or two business days. Also, due to the short float time afforded by the invention, merchants will be willing to accept higher value coupons, e.g., $5.00, $10.00, $50.00 or more. Thus, manufacturers and others that would previously engage in a rebate by mail program to provide consumers with large discounts on higher-cost items such as appliances can now simply provide coupons with the desired discount. Consumers will be more responsive to such offers since they receive the discount at the time of purchase rather than having to wait several weeks for a rebate by mail. These rebates could be called “coupon rebates.” The invention thus enables a paradigm shift in how coupons are approached by moving them from an arena in which they provide modest savings of, e.g., a dollar or less previously, to an arena in which purchases of thousands of dollars are routinely handled. Moreover, higher-value coupons discounts are afforded the same protections of the existing credit and debit card processing infrastructure.

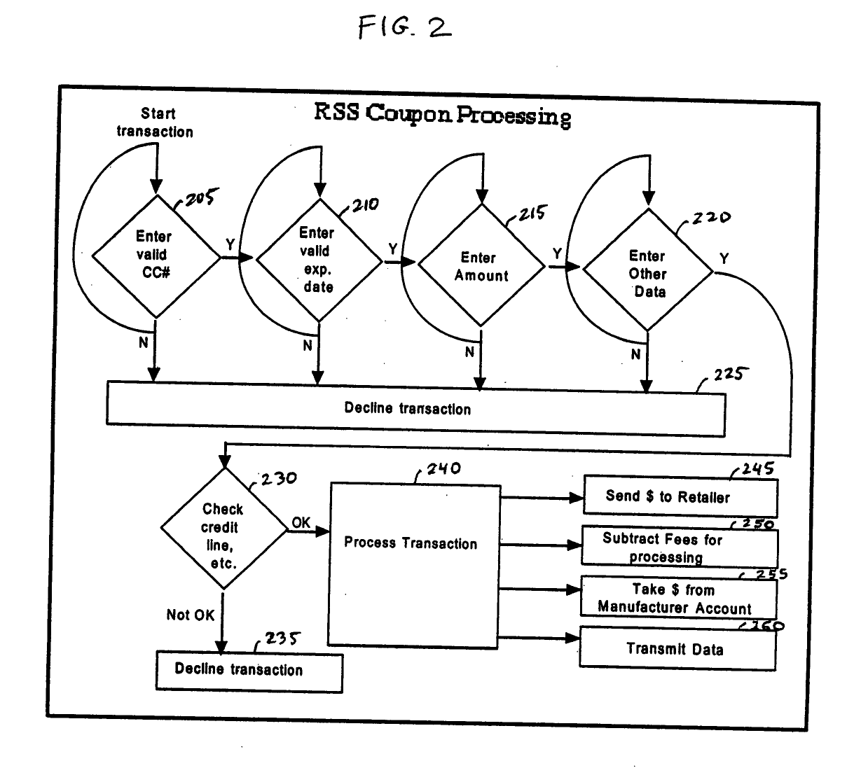

FIG. 2 illustrates a coupon processing method. Steps 205 through 225 may occur at the POS location 100, while steps 230 through 260 may occur at the processing center 135. At block 205, the credit card number is read and entered from the coupon 105. If the information received does not appear to be a valid credit card, e.g., based on the number of digits or other criteria, the transaction is declined (block 225). At block 210, the expiration date of the coupon is examined to determine whether the coupon has expired. If so, the transaction is declined. At block 215, the amount of the discount is obtained. If the amount cannot be read, or appears to be inconsistent with the product or other criteria, the transaction is declined. At block 220, other data that is encoded in the coupon is obtained. This data includes the new information that can be encoded using the techniques of the present invention, such as information relating the distribution and redemption of the coupons, and information relating to the consumers who redeem them, including general demographic data, and specific data associated with the individual, if available.

If the above steps are completed successfully, the coupon transaction information is processed further. At block 230, the issuer's credit or debit account may be checked to see if it is in good standing and whether there is a sufficient credit line. This may involve obtaining an authorization code as discussed above. Generally, reputable coupon issuers such as large manufacturers may be extended credit by the processing facility, which reimburses the merchants before obtaining payment from the manufacturer. In other cases, the processing facility may require that the issuer provide a cash deposit before the merchants are paid. An account for paying for the coupon discounts may have funds transferred to it by the issuer based on credit card protocols. The account may have a minimum balance and replenishment rate attached to it. If a problem is detected in this regard, the transaction is declined (block 235). Assuming no such problems are detected, at block 240, the transaction is processed, the result of which may include sending funds to the retailer or other merchant (block 245), subtracting fees for processing (block 250), and taking funds from the manufacturer's, e.g., coupon issuer's, account (block 255). Since the coupons are processed like credit card transactions, the money is taken from the issuer's account and transferred to the merchant's account in accordance with the offer codes provided in the coupon transaction information and the particular details of the transaction handling as established between the issuer and processing unit. At block 260, the additional data regarding demographics and the like, can be communicated to a facility for further analysis and marketing research. Reports developed from the coupon transaction information can be amassed and periodically presented to the coupon issuer. The coupon issuer might select from monthly, weekly, daily or other time intervals to receive informational reports and schedule reimbursement payments to the merchants.

In particular, the coupon issuer or other entity may employ software to process the wealth of new coupon information that is available. By coordinating the coupon formats, the advertisers and retailers can devise methods to provide highly-targeted marketing, and marketing for gathering consumer purchasing habits, consumer demographics, and the like. For example, the coupon information may include information relating to the distribution and redemption of the coupons, and the particular consumers who redeemed them. The distribution information may include the geographical location in which the coupon was distributed, the specific distribution media, e.g., name of a newspaper or magazine, even the specific edition of a newspaper, e.g., morning afternoon or evening, and the date of issuance of the media. Moreover, coupons that are provided to specific consumers, e.g., in a direct mailing, can be individually encoded with the consumers' identities or demographic information regarding age, education, income, family status, previous purchasing habits, and so forth.

Coupons that consumers print from a web site, e.g., web-based coupons, can also include specific information relating to the consumer that is obtained from the consumer's interaction with the web site. An Internet web site that allows the consumer to select from a variety of coupons and print them out for redemption can be uniquely identified and serialized to prevent duplicate use. The consumers receive data from the web site for use in printing coupons using their own computers and printers. Such coupons may appear the same as coupons printed in other media, e.g., having a bar code, picture of the product, merchant information about redemption, restrictions, the offer code, the discount amount and expiration date. The coupon is presented at the store and processed the same as a coupon that was printed by the coupon issuer. The unique encoding method and serialized number insure that the coupon is not used twice or duplicated. The consumer can be warned against duplicate use. The coupon can also have the consumer's name. The additional demographic information is conveyed to the manufacturer during coupon processing.

For instance, the consumer may be asked to respond to a survey to obtain a coupon for a discount on an item of interest. The coupon printed out by the consumer using data from the web site can include information obtained from the responses. Moreover, a consumer can be given a cash payment or award for interacting with the web site by receiving data for printing a coupon that designates the consumer is to receive a payment or award. In this case, the credit or debit card number or other account identifier, such as a bank account identifier, e.g., checking or savings account number, is encoded in the coupon along with the credit or debit card number of the coupon issuer, e.g., the sponsor of the survey. The consumer's responses to the survey can also be encoded in the coupon. Processing of the coupon is similar to the manner in which a consumer obtains a credit when returning an item that has been purchased with a credit or debit card. Alternatively, an electronic funds payment can be made to the consumer's checking or savings account. Or, the consumer may be awarded points, analogous to frequent flyer miles that can be redeemed for products or services. The term “award” or the like is meant to encompass any such payment or award to the consumer as discussed herein. The award may be given following the consumer's interaction with the web site with no further requirements.

For example, the manufacturer could set up a website where the customer is invited to participate with the added incentive of earning money. The customer fills in his or her own credit or debit card information with expiration date, account number and street address. For a survey, a website might state: “Take five minutes to answer the following ten questions and earn $1.00 from Proctor and Gamble.” The customer fills in the survey, then fills in a set of text fields which ask for the customer's credit or debit card, expiry date, and street address for security purposes. Then the customer prints the resulting coupon and brings it to a merchant to process. In another approach, the website states: “Enter a contest to win to $1,000,000 instantly from Proctor and Gamble.” The customer fills in the entry blank and a set of text fields as discussed, and the entry is submitted to the website server to determine if the customer is a winner. The customer can be notified right there on line and obtain data to print a coupon to claim the prize. Or, the consumer may bring the coupon to an authorized merchant to see if he or she has won a prize.

A further advantage of the coupons of the present invention is that the additional information that is carried allows the coupon issuer to be a different entity than the manufacturer of the product. This opens up many opportunities for cross-marketing and other new types of marketing and commerce. In contrast, a conventional coupon only carries the UCC company number, which identifies the manufacturer, and which must be the same as the code on the product to which the coupon applies. For example, a bar code according to the invention may have a conventional portion that identifies the manufacturer via the UCC company number, and an additional portion, such as a two-dimensional bar code portion, that identifies the account identifier of another party. To illustrate, a health club may issue a coupon that allows a consumer to obtain a discount on exercise equipment or health foods products, or a hotel may issue a coupon that allows a consumer to obtain a discount on a car rental, or an admission fee to a local attraction. In another example, an individual can print a coupon as a gift that allows the recipient to obtain a discount on a certain product or service.

Various bar code symbologies that may be used are discussed below. Generally, a bar code symbol according to the invention may look like one of the existing coupon linear formats, e.g., UPC A or UCC-EAN-128, but adds a two-dimensional symbol such as an RSS symbol. Depending on how the checkout counter at a POS location is designed, the scanner may be able to seek the additional information from either symbol. For example, if the scanner is designed to seek RSS two-dimensional additional data if it sees a UPC (A) code with a leading digit of ‘5’, indicating that it is a coupon, then the RSS two-dimensional data may be added to the UPC (A) code. If, on the other hand, the UCC/EAN-128 portion of the coupon has been properly formatted, the scanner may seek additional information if it encounters such a symbol. UCC/EAN-128 codes may be read as the linear portion of an RSS symbol if the symbol contains both the flag and linkage characters necessary to cause the scanner to understand it to be the linear portion of an RSS symbol. Fortunately, the scanner can read the UCC/EAN-128 code with or without the flag and linkage characters and may be designed to work both ways.

A further aspect of the invention involves a computer such as a personal computer that is programmed to create the bar code symbols disclosed herein, as well as a computer program product having software for enabling the computer to create such bar code symbols providing the functionality disclosed herein. Any known software development and computer programming techniques may be used for this purpose. Barcode Technology is one supplier of such software.

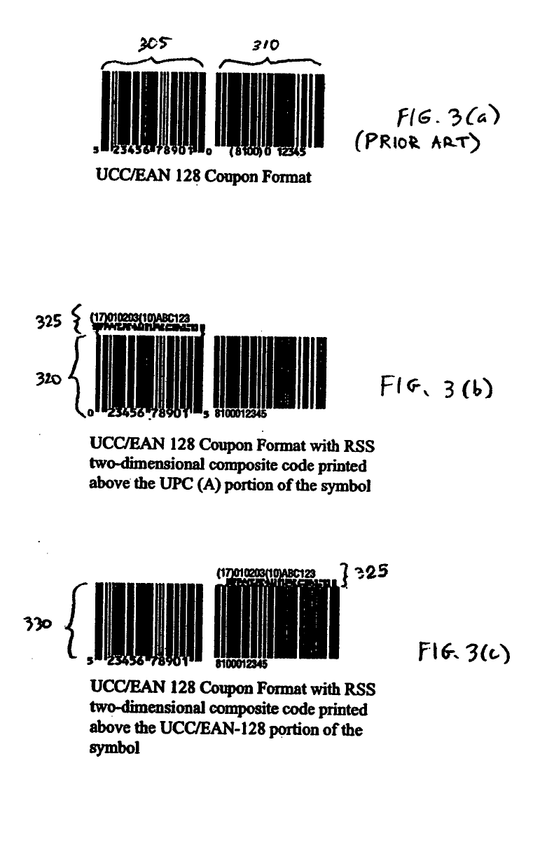

FIG. 3(a) illustrates a conventional UCC/EAN-128 coupon format. The symbol is linear or 1-D since it includes only vertical lines. The symbol includes two bar codes side by side, namely the UPC (A) Universal Product Code symbol 305 on the left, and the UCC-EAN-128 symbol 310 on the right. The two pieces of information can be scanned in a single operation by scanners designed for this purpose.

FIG. 3(b) illustrates a first embodiment of a two-dimensional bar code combined with a UCC/EAN-128 bar code. The symbol includes a UCC/EAN-128 coupon format 320 with an RSS two-dimensional composite code 325 printed above the UPC (A) portion of the symbol. By conforming to the standards of UCC/EAN 128 coupon formats, the additional RSS two-dimensional information allows both retailers equipped with the new RSS scanners and those without the new equipment to use the same coupons. Those with the new scanners that can read the RSS information will benefit by having the coupons processed in the new way discussed herein. Those without the new RSS scanners will continue to accept coupons as they have always done.

FIG. 3(c) illustrates a second embodiment of a two-dimensional bar code combined with a UCC/EAN 128 bar code. The symbol includes a USS/EAN 128 coupon format 330 with the RSS two-dimensional composite code 325 printed above the UCC/EAN-128 portion of the symbol.

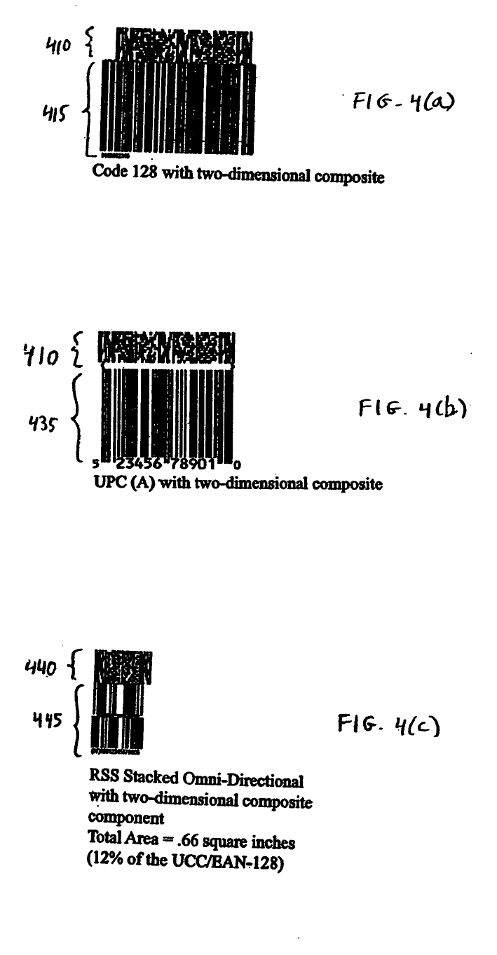

FIGS. 4(a)-(c) are examples of bar code symbols whose design is not constrained by a requirement to conform to the standards of UCC/EAN 128 coupon formats. They provide RSS Coupons that are totally redesigned to minimize the size of the bar code and reflect the type of informational exchange discussed herein with the additional RSS two-dimensional bar code.

FIG. 4(a) illustrates a two-dimensional bar code combined with a Code 128 bar code. The symbol includes a two-dimensional composite bar code 410 printed above a Code 128 bar code 415.

FIG. 4(b) illustrates a two-dimensional bar code combined with a UPC (A) bar code. The symbol includes the two-dimensional composite bar code 410 printed above a UPC (A) bar code 435.

FIG. 4(c) illustrates a two-dimensional bar code combined with a stacked bar code. The symbol includes a two-dimensional composite 440 above an RSS stacked omni-directional component 445.

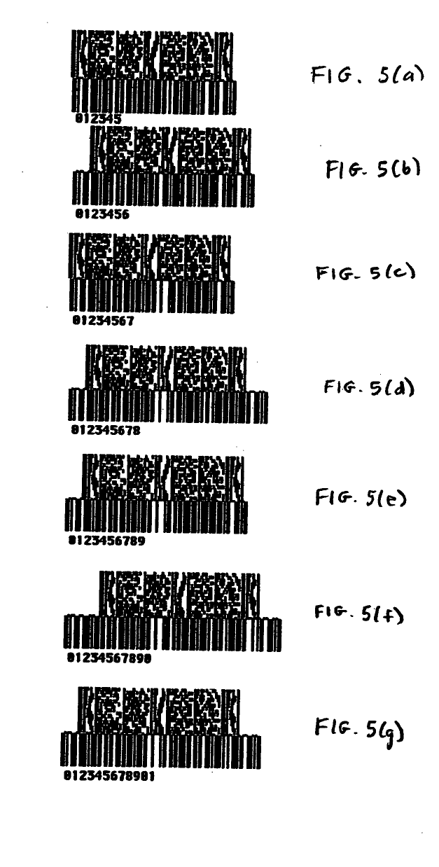

FIGS. 5(a)-(g) illustrate examples of optimized coupon bar codes. These are further examples of bar code symbols whose design is not constrained by a requirement to conform to the standards of UCC/EAN 128 coupon formats. They provide RSS coupons that are totally redesigned to minimize the size of the bar code and reflect the type of informational exchange discussed herein with the additional RSS two-dimensional bar code. The bar codes represent different sizes that may be used. The different configurations and types of RSS symbols allow them to be used in different ways. Each code includes a linear portion carrying a different number of characters, and consequently having a different width, while the 2-D portion in each example is the same. For example, the linear portions of FIGS. 5(a)-(g) carry six through twelve digits, respectively.

Since the coupons may use smaller bar code symbols, the overall coupon size can be decreased or more human-readable promotional information can be provided. For example, the total area of the format of FIG. 4(c) is 0.66 square inches, or 12% of the 5.25 square inch area of the UCC/EAN 128 coupon format of FIG. 3(a). RSS coupons also can carry an additional sixty characters of data. Advertising costs can be reduced since fewer pages are needed to provide the same coupon offers. Or, additional space in the coupon can be devoted to graphics and the like. Environmental benefits due to reduced paper use result as well.

The bar-coded coupon symbols disclosed herein also provide increased information beyond the amount of information that a typical UCC/EAN-128 coupon format holds, e.g. the offer number, serial number, expiration date, product identification, family code and value code. RSS variations allow 56, 338, or 2363 more characters of information beyond the fourteen characters of the UCC/EAN 128 coupon format. The 338-character format is believed to be suitable at present.

Standardized formats can be provided for the additional information that the coupons can contain. For example, the additional information beyond the standard UCC/EAN-128 Coupon Formats may include: the Global Trade Item or Identification Number (GTIN) with the Application Identifier (AI) of (01), the Date with AI (20), the Time, the Offer Code, the Offer Expiration Date, the Sub-Offer Code, the Issue Date, and a unique serial number. For example, offer code “12345” may be assigned to coupons for Brand X soap printed in the NY Times newspaper on Sunday Aug. 24, 2002 and distributed in the New York Metropolitan Region. The sub-offer code may identify whether the coupon appeared in the morning, afternoon or evening edition of the newspaper.

Another problem of existing coupon formats is the limited area devoted to family codes. A family code is designed by the manufacturer to indicate which set of products the coupons are targeted. However, due to the nature of various company product lines, this is not always sufficient to make distinctions between products. Accordingly, enhanced family code information can be encoded using the additional data-carrying capacity of the coupons of the present invention.

The coupons may also be coded with the expiration date of the credit or debit card account and/or the expiration date of the individual coupon offer, the latter of which is used to establish the validity of the coupon for redemption during processing. Since a manufacturer can have more than one coupon offer running simultaneously, the expiration dates may vary from coupon to coupon. The RSS coupon may also contain specific information put into it by the manufacturer in preparation for a particular method of distribution. For example, if readers of a certain magazine or newspaper have a particular set of demographics, those demographic statistics can be inserted in the coupons that are printed in the magazine so that during redemption, that information is passed along to the manufacturer.

In addition to the above-mentioned information, the entire string of characters in the coupon can be encrypted and hold a CRC code and security code. The CRC code serves to check the data integrity and greatly reduce or eliminate duplicate and fraudulent coupons. Since the coupons can be printed with a greater degree of specificity, patterns of fraud and duplication can more easily be detected. Other safeguards can be provided to avoid fraudulent use of the credit and debit card numbers, such as reserving specified number sequences for credit and debit cards that are used for coupons, and applying associated transaction limits based on the discount offered. Moreover, the credit or debit card account of an issuer can have an expiration date associated with it according to the coupon's expiration date.

The information contained in the two-dimensional portion of the RSS coupon may be encoded to prevent others from being able to read and use that same information, and to prevent the processing center from being able to read the enclosed information, which is made available only to the coupon issuer.

Further, to reduce duplicates and fraud, mass printed coupons can more easily be differentiated by assigning unique offer codes and sub offer codes.

A further advantage of the present invention is that it allows small businesses, individuals and other entities to issue coupons. In comparison, under the conventional system, only companies who hold UCC/EAN numbers can sponsor coupons using the existing UCC/EAN-128 coupon formats. With the coupon redemption system described herein, the system is opened up to any company, person or other entity that has a credit or debit card account and a personal computer with bar code printing software, regardless of whether or not they are a manufacturer in the UPC system. New commercial opportunities are expected to result.

To create a system whereby the coupons can optimally be used and redeemed via a credit or debit card transaction system, several technologies and business practices should be put in place, including:
a. Bank Partnering—Banks must be setup to process coupon issuer's credit or debit card accounts in contractual arrangements with escrow accounts and minimum balances.
b. Processing/Scanners—Use “Verifone” or other credit card processing machines which can accept the coupon information from coupons. Use bar code scanners that can read RSS coupons and traditional coupons and talk to the credit card processing machine.
c. Retailer Acceptance—Retailers must be willing to change internal software to read and understand RSS coupon information, upgrade checkout scanners to read RSS coupons, or double scan coupons with both their traditional system and the newly installed 2-D Verifone/scanners and telephone line, and give up their current redemption processor.
d. Manufacturer Acceptance—Manufacturers must be willing to print coupons with the additional RSS information included in them, e.g., using software from Barcode Technology.
e. Customer Acceptance—Customers must be willing to use RSS coupons. This should not be a problem since the bar code type is of little concern to consumers. The product and discount are of most concern.

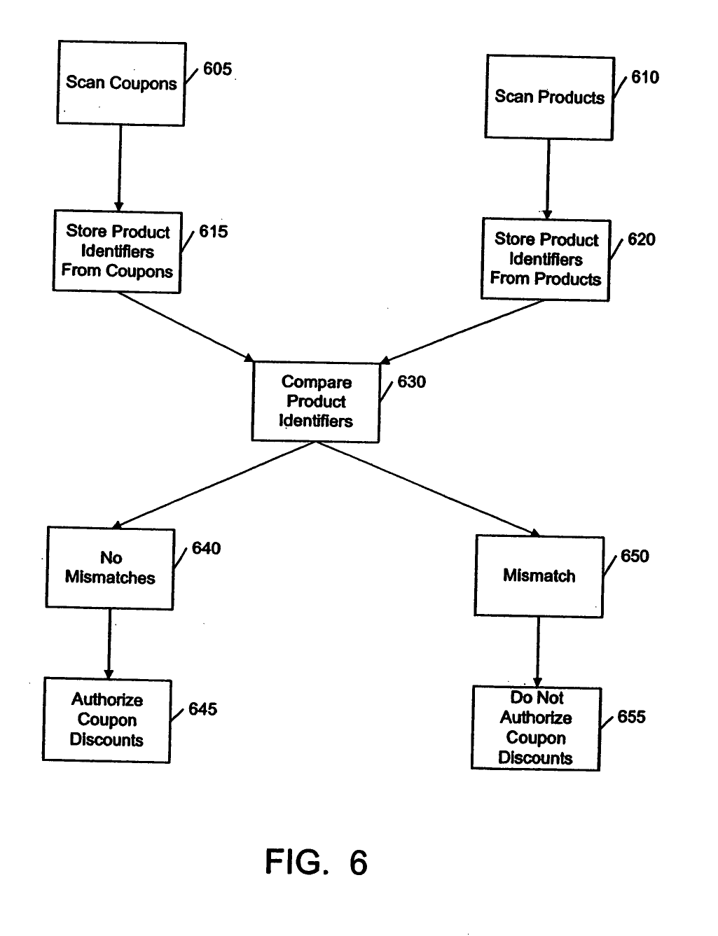

FIG. 6 illustrates a method for ensuring that coupons are redeemed only when the associated product has been purchased.

One problem of traditional coupon processing is that the merchant's computer system is not aware of new coupons as they are issued. This makes it difficult for the merchant's computer system to know what to do with, or how to handle, new coupon offers. For example, a security method that insures that the associated products for a given coupon are actually present in the customer order requires that the computer system know which products and product families are to be associated with the offer. If that information were known, then the scanner and computer could double check to see that the UPC (A) code exists for the products and coupons associated with the products being purchased. To solve the problem, the RSS coupon itself could contain the associated product identifier, such as the Global Trade Item Number (GTIN) information. The GTIN is a 14-digit number that provides more specific information than the 12-digit UPC code in the form of a packaging designator. For example, the UPC code might identify a product such as soap, while the GTIN also indicates whether the soap is packaged as a single item, six-pack, or carton. The computer could read the coupon and the associated product GTIN and examine the other products in the transaction for the presence of that GTIN or UPC (A) code. If there is a match, coupon redemption is authorized. The UPC-A Bar Code Symbol is a bar code symbol of the EAN/UPC Symbology that encodes UCC-12 Identification Numbers. See FIG. 4(b). GTINs could be available on all RSS bar coded coupons. If we had to emulate the older style UCC/EAN-128 Coupon Formats, we would put the 2-D portion of the coupon above the UPC left half or EAN-128 right half of an existing bar code symbol type. In those cases there would be no GTIN present.

The above process is illustrated in FIG. 6. At block 605, the coupons that are provided in accordance with the invention are scanned in at the POS. The products that are being purchased are also scanned (block 610). These steps may occur in any order. At block 615, product identifiers that are provided in the coupons are temporarily stored, and at block 620, the product identifiers from the bar codes on the products are also stored. These product identifiers may be GTIN codes. At block 630, which may be performed when the consumer's order is totaled, a determination is made as to whether any of the product identifiers from the coupons do not have a match with a product identifier from the products that are being purchased. If there is no mismatch (block 640), the coupon discounts are authorized (block 645). If there is a mismatch (block 650), the coupon discounts are not authorized. Moreover, a message may be generated, e.g., on the cash register and display, to inform the cashier and consumer of the specific coupon that has not been authorized. Advantageously, unauthorized and fraudulent coupon redemptions can be curtailed.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect or import of the methods described.

1. A method of managing information between businesses and vendors, comprising:
a developer creating a system through which a business receives information associated with items provided to the business by a supply chain of at least one vendor, wherein the system comprises a specification and one or more subsystems, wherein the specification is defined by at least the business and the specification defines the type of information to be received through the system, and wherein each of the one or more vendor subsystems enables an operator of the respective vendor subsystem to provide information conforming to the specification to the business by storing the conforming information in information storage devices and associating the information storage devices with items that are provided to the business; and
the business facilitating installation of the system across the supply chain by requiring one or more of the at least one vendor to purchase one of the one or more vendor subsystems from the developer and operate the purchased vendor subsystem to provide information to the business as a condition to maintaining a business relationship with the business.

2. The method of claim 1, wherein the information storage devices comprise bar codes.

3. The method of claim 2, wherein the information storage devices comprise RSS bar codes.

4. The method of claim 1, wherein the information storage devices comprise RFID tags.

5. The method of claim 1, further comprising the developer paying a fee to the business for facilitating installation of the system across the supply chain.

6. The method of claim 5, wherein the fee is based on the purchases of the subsystems from the developer by the one or more of the at least one vendor.

7. The method of claim 1, wherein the system comprises a business subsystem that enables the business to obtain information from the information storage devices associated with the items the business receives from each of the vendors operating a vendor subsystem, and that enables the business to send data to one or more of the vendors operating a vendor subsystem, wherein the data relates to the items previously received by the business from the one or more of the vendors operating a vendor subsystem.

8. A method of managing information associated with items between a business and one or more vendors, the method comprising:
accessing, at the business, data from data storage devices associated with items received by the business from the one or more vendors, wherein the data stored in the data storage devices was selected by the one or more vendors based on requests issued by the business;
the business sending at least a portion of the accessed data to the one or more vendors; and
determining, by the one or more vendors, sales related information associated with the items based on the sent portion of accessed data provided by the business to the one or more vendors.

9. The method according to claim 8, wherein accessing data associated with the items comprises reading a bar code label.

10. The method according to claim 8, wherein the bar code label comprises a Reduced Space Symbology (RSS) bar code.

11. The method according to claim 8, wherein the bar code label comprises two-dimensional symbology.

12. The method according to claim 8, wherein accessing data associated with the items comprises receiving the accessed data from a Radio Frequency Identifier (RFID) device.

13. The method according to claim 8, wherein data associated with the items comprises product information.

14. The method according to claim 8, wherein the sales related information associated with the items comprises reordering requirement information.

15. The method according to claim 14, wherein the reordering requirement information enable the one or more vendors to adjust production levels.
